(19) United States
(12) Patent Application Publication
(10) Pub. No.: US 2023/0193136 A1
(43) Pub. Date: Jun. 22, 2023

(54) METHOD OF FORMING A FIRE RESISTANT ADDITIVE EMPLOYING CARBON NANOTUBES FOR INCORPORATION INTO AN ARTICLE

(71) Applicant: Pipedream Industries, Inc., Stockbridge, GA (US)

(72) Inventors: Dishank Patel, Lawrenceville, GA (US); Dhaivil Patel, Lawrenceville, GA (US)

(21) Appl. No.: 17/961,325

(22) Filed: Oct. 6, 2022

Related U.S. Application Data
(60) Provisional application No. 63/252,791, filed on Oct. 6, 2021.

(51) Int. Cl. C09K 21/02; C08K 13/06; C08J 3/20; C09D 5/18; C09D 7/62; C09D 7/63; C09D 7/45

(52) U.S. Cl. CPC C09K 21/02; C08K 13/06; C08J 3/203; C09D 5/18; C09D 7/62; C09D 7/63; C09D 7/45; C08K 2201/011; C08K 3/041

(57) ABSTRACT

An exemplary embodiment of the present disclosure provides a fire resistant material and methods of making same, the fire resistant material comprising a material incorporating a mixture comprising carbon nanotubes, nanoclay, and a dispersing agent.

### CROSS-REFERENCE TO RELATED APPLICATIONS

This application claims the benefit of U.S. Provisional Application Ser. No. 63/252,791, filed on 6 Oct. 2021, which is incorporated herein by reference in its entirety as if fully set forth below.

### FIELD OF THE DISCLOSURE

The various embodiments of the present disclosure relate generally to fire resistant materials, and more specifically to the incorporation of fire resistant materials into an article.

### BACKGROUND

Conventional approaches to imparting fire retardant properties to a product involve the use of metal hydrates (e.g., aluminum hydrate) or ammonium phosphates (e.g., ammonium polyphosphate) as a fire retardant in polymeric plastics and resins. This technology typically consists of mixing powdered mineral fire retardant alongside polymeric plastics and resin during the molding or compounding process. The powder is then incorporated into the polymeric plastic resin and melt mixed together (e.g., compounded in a twin screw). The results is a polymeric plastic resin that has a lower impact strength, lower tensile strength, lower yield strength, lower tensile strain, lower tensile stress, lower modulus of elasticity, and hence can easily suffer from brittle breaks. Further, when the plastic is exposed to a flame, the plastic slightly expands on the surface and forms a char layer. The internal plastic then heats up and begins to form a pool of liquid plastic. Another drawback of conventional plastic fire retardants is that they require a minimum loading of 15% by weight to pass fire regulation so as to be effective in preventing the spread of any flame.

Thus, there is a need for fire-resistant materials and methods of making same that can maintain the structural strength while also being resistant to catching fire or melting under direct heat or flame.

### BRIEF SUMMARY

The present disclosure relates to a fire resistant material. An exemplary embodiment of the present disclosure provides a material incorporation a mixture, the mixture comprising carbon nanotubes, nanoclay, and a dispersing agent.

In any of the embodiments disclosed herein, the carbon nanotubes can include approximately 25 percent by weight of the mixture. The nanoclay can include approximately 50 percent by weight of the mixture. The dispersing agent can include approximately 25 percent by weight of the mixture. The material can incorporate the mixture such that the material is self-extinguishing when exposed to a flame.

In any of the embodiments disclosed herein, the nanoclay can comprise one or more silicates.

In any of the embodiments disclosed herein, the dispersing agent can include a surfactant. In some embodiments, the dispersing agent can include a plasticizing agent.

In some embodiments, the fire-resistant material can be configured to be coated on a surface. In some embodiments, the fire-resistant material can be configured to be molded.

An exemplary embodiment of the present disclosure provides a method of making a fire resistant material. The method can include combining a mixture with a polymeric resin, heating the mixture, and extruding the fire resistant material into pellets. The mixture can include carbon nanotubes, nanoclay, and a dispersing agent. Heating the mixture with the polymeric resin can form the fire resistant material.

An exemplary embodiment of the present disclosure provides a method of making a fire resistant material. The method can include combining a mixture with a monomer resin, adding an activation agent, heating the mixture, and extruding the fire resistant material into pellets. The mixture can include carbon nanotubes, nanoclay, and a dispersing agent. Heating the mixture with the monomer resin can form the fire resistant material.

An exemplary embodiment of the present disclosure provides a method of making a fire resistant material. The method can include combining a mixture with a polymeric powder under applied pressure, heating the mixture, and extruding the fire resistant material into pellets. The mixture can include carbon nanotubes, nanoclay, and a dispersing agent. Heating the mixture with the polymeric powder can form the fire resistant material.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a method for manufacturing a fire resistant material, in accordance with an exemplary embodiment of the present invention.

FIG. 2 provides a method for manufacturing a fire resistant material, in accordance with an exemplary embodiment of the present invention.

FIG. 3 provides a method for manufacturing a fire resistant material, in accordance with an exemplary embodiment of the present invention.

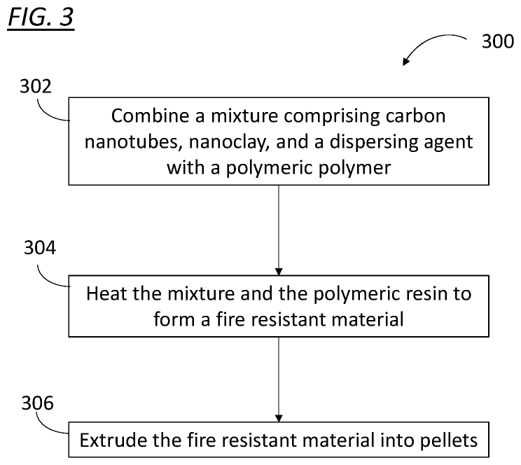

FIG. 4 provides a schematic illustrating a method for manufacturing a fire resistant material, in accordance with an exemplary embodiment of the present invention.

FIG. 5 provides a schematic illustrating a method for manufacturing a fire resistant material, in accordance with an exemplary embodiment of the present invention.

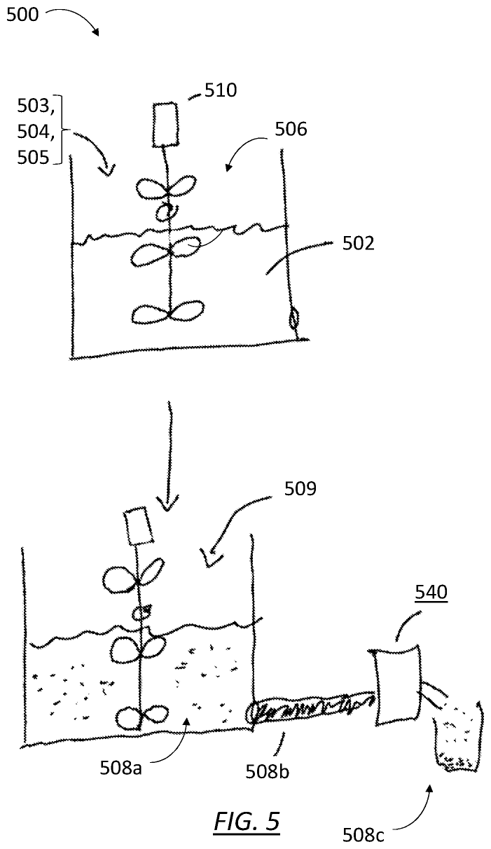

FIG. 6 provides a schematic illustrating a method for manufacturing a fire resistant material, in accordance with an exemplary embodiment of the present invention.

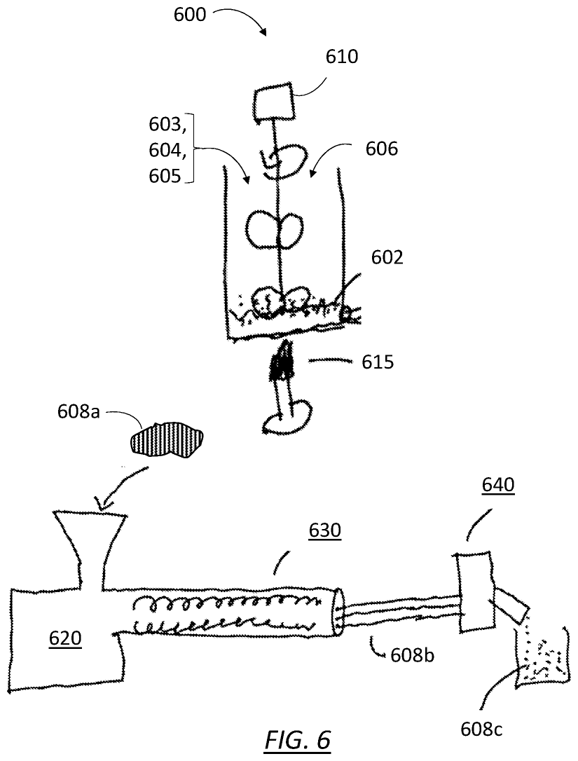

FIGS. 7A and 7B provide schematic illustrations of methods for combining ingredients to form a fire resistant mixture, in accordance with an exemplary embodiment of the present invention.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

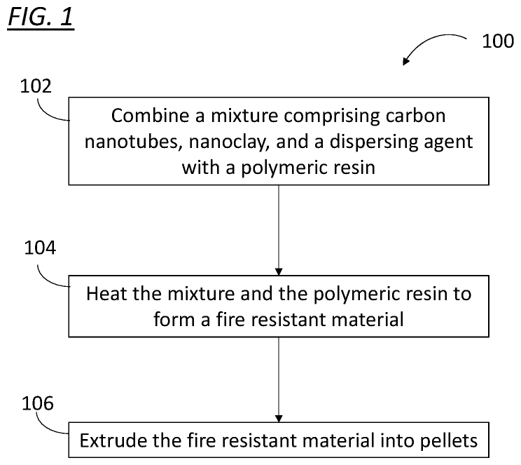

As shown in FIG. 1, an exemplary embodiment of the present invention provides a method 100 of making a fire resistant material. Method 100 can include combining 102 a mixture with a polymeric resin, heating 104 the mixture, and extruding 106 the fire resistant material into pellets. The mixture can include carbon nanotubes, nanoclay, and a dispersing agent. Heating the mixture with the polymeric resin can form the fire resistant material.

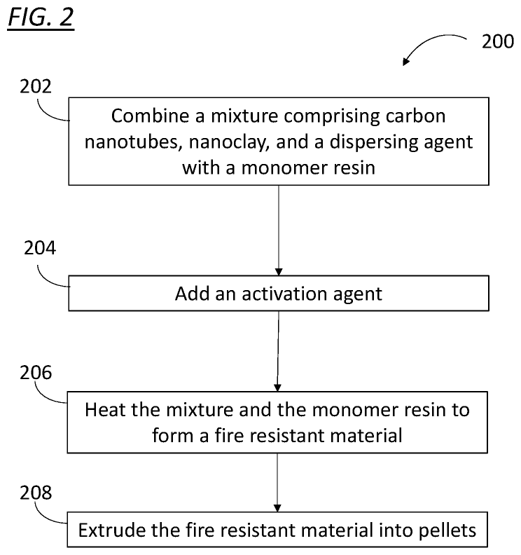

As shown in FIG. 2, an exemplary embodiment of the present invention provides a method 200 of making a fire resistant material. Method 200 can include combining 202 a mixture with a monomer resin, adding 204 an activation agent, heating 206 the mixture, and extruding 208 the fire resistant material into pellets. The mixture can include carbon nanotubes, nanoclay, and a dispersing agent. Heating the mixture with the monomer resin can form the fire resistant material.

As shown in FIG. 2, an exemplary embodiment of the present invention provides a method 300 of making a fire resistant material. Method 300 can include combining 302 a mixture with a polymeric powder under applied pressure, heating 304 the mixture, and extruding 306 the fire resistant material into pellets. The mixture can include carbon nanotubes, nanoclay, and a dispersing agent. Heating the mixture with the polymeric powder can form the fire resistant material.

The present invention is directed to a fire resistant additive mixture that can be incorporated into or mixed with other materials, chemicals and compounds to form a resultant mixture. The resultant mixture can be incorporated into any selected type of material, and if desired, the material can be subsequently shaped, formed or manufactured into an object or article. According to one practice, the fire resistant additive mixture can be added to or incorporated in polymeric plastics and resins. The additive mixture of the present invention includes at least one or more types and/or derivatives of carbon nanotubes, one or more types and/or derivatives of nanoclay, and one or more dispersing agents.

As used herein, the term “fire resistant” is intended to mean any selected compound, material, mixture or article that can be used to provide or add non-flammable properties to a chemical, compound, mixture, material, object or article. That is, the compound, material, mixture or article is inherently resistant to catching fire (self-extinguishing) and does not melt or drip when exposed directly to extreme heat or a flame.

As used herein, and unless specified, the term “carbon nanotube” (CNT, plural CNTs) refers to tubes formed of carbon with diameters measured in nanometers. CNTs can take on any number of cylindrically-shaped allotropes of carbon of the fullerene family including graphene, vapor grown carbon fibers, carbon nanofibers, single-walled CNTs (SWCNTs), double-walled CNTs (DWCNTs), and multi-walled CNTs (MWCNTs). CNTs can be capped by a fullerene-like structure or open-ended. CNTs can range from about 1 to about 100 nm in diameter. In some examples, CNTS of larger diameter (e.g., greater than 100 nm) can form fibers of CNTs. The system and methods described herein can selectively include SWCNTs, DWCNTs, MWCNTs, or CNT fibers of uniform lengths and diameters. In some embodiments, the CNTs can have an indeterminate or undetermined wall structure.

As used herein, the term “nanoclay” refers to mineral silicates or silicate salts having single or multiple layers, where each layer has a thickness in the nanometer range. In some embodiments, the silicate salt may include potassium silicate, sodium silicate, aluminum silicate, calcium silicate, zirconium silicate, cobalt(II) orthosilicate, iron(II) orthosilicate, lithium orthosilicate, or combinations thereof. Depending on the chemical composition and nanoparticle morphology, the nanoclays can be organized into several classes, such as montmorillonite, bentonite, kaolinite, hectorite, and halloysite. Plate-like montmorillonite is preferably employed in connection with the present invention. The montmorillonite type of nanoclay consists of about 1.0 nm thick aluminosilicate layers surface-substituted with metal cations and stacked in about 10 pm-sized multilayer stacks. Depending on surface modification of the clay layers, montmorillonite can be dispersed in a polymer matrix to form polymer-clay nanocomposite. The carbon nanotubes and the nanoclay can be modified and grafted together. The grafting together of these constituent components forms modified matrices which are then plasticized alongside dispersing agents and then mixed together.

As used herein, the term “dispersing agent” is intended to include any selected material, chemical, surfactant, small molecule, polymer, or mixture that assists with or helps lower the viscosity of the resultant mixture when melted to a liquid, which helps disperse the nanomaterials therein. A variety of surfactants can be included in the present mixture. Accordingly, the surfactants for use in the present invention may be anionic, including, but not limited to, sulfonates such as alkyl sulfonates, alkylbenzene sulfonates, alpha olefin sulfonates, paraffin sulfonates, and alkyl ester sulfonates; sulfates such as alkyl sulfates, alkyl alkoxy sulfates, and alkyl alkoxylated sulfates; phosphates such as monoalkyl phosphates and dialkyl phosphates; phosphonates; carboxylates such as fatty acids, alkyl alkoxy carboxylates, sarcosinates, isethionates, and taurates. Specific examples of carboxylates are sodium cocoyl isethionate, sodium methyl oleoyl taurate, sodium stearate, sodium laureth carboxylate, sodium polyacrylate, sodium trideceth carboxylate, sodium lauryl sarcosinate, sodium carboxymethyl cellulose, lauroyl sarcosine, and cocoyl sarcosinate. Specific examples of sulfates include sodium dodecyl sulfate (SDS), sodium lauryl sulfate, sodium lauryl ether sulfate, cationsodium laureth sulfate, sodium trideceth sulfate, sodium tridecyl sulfate, sodium cocyl sulfate, and lauric monoglyceride sodium sulfate.

In some embodiments, the surfactants for use in the present invention may also be cationic, so long as at least one surfactant bearing a net positive charge is also included. Such cationic surfactants include, but are not limited to, primarily organic amines, primary, secondary, tertiary or quaternary. For a cationic surfactant, the counter ion can be chloride, bromide, methosulfate, ethosulfate, lactate, saccharinate, phosphate, acetate, and other organic acid anions. Examples of cationic amines include polyethoxylated oleyl/stearyl amine, ethoxylated tallow amine, cocoalkylamine, oleylamine, and tallow alkyl amine.

The surfactants for use in the present invention may be nonionic, including, but not limited to, polyalkylene oxide carboxylic acid esters, fatty acid esters, fatty alcohols, ethoxylated fatty alcohols, poloxamers, polyalkylene oxidesm alkanolamides, polyacrylamides, alkoxylated alkanolamides, polyethylene glycol monoalkyl ether, and alkyl polysaccharides. Polyalkylene oxide carboxylic acid esters have one or two carboxylic ester moieties each with about 8 to 20 carbons and a polyalkylene oxide moiety containing about 5 to 200 alkylene oxide units. An ethoxylated fatty alcohol contains an ethylene oxide moiety containing about 5 to 150 ethylene oxide units and a fatty alcohol moiety with about 6 to about 30 carbons. The fatty alcohol moiety can be cyclic, straight, or branched, and saturated or unsaturated. Some examples of ethoxylated fatty alcohols include ethylene glycol ethers of oleth alcohol, steareth alcohol, lauryl alcohol and isocetyl alcohol. Poloxamers are ethylene oxide and propylene oxide block copolymers, having from about 15 to about 100 moles of ethylene oxide. Alkyl polysaccharide (“APS”) surfactants (e.g. alkyl polyglycosides) contain a hydrophobic group with about 6 to about 30 carbons and a polysaccharide (e.g., poly glycoside) as the hydrophilic group.

The surfactants for use in the present invention may be zwitterionic, meaning the same molecule has both a formal positive and negative charge. The positive charge group can be quaternary ammonium, phosphonium, or sulfonium, whereas the negative charge group can be carboxylate, sulfonate, sulfate, phosphate or phosphonate. Similar to other classes of surfactants, the hydrophobic moiety may contain one or more long, straight, cyclic, or branched, aliphatic chains of about 8 to 18 carbon atoms. Specific examples of zwitterionic surfactants include alkyl betaines such as cocodimethyl carboxymethyl betaine, coco betaine, lauryl dimethyl carboxymethyl betaine, lauryl dimethyl alpha-carboxyethyl betaine, cetyl dimethyl carboxymethyl betaine, lauryl bis-(2-hydroxyethyl)carboxy methyl betaine, stearyl bis-(2-hydroxypropyl)carboxymethyl betaine, oleyl dimethyl gamma-carboxypropyl betaine, and lauryl bis-(2-hydroxypropyl)alphacarboxy-ethyl betaine, amidopropyl betaines; lecithins (phosphatidylcholine), such as soy lecithin; and alkyl sultaines such as cocodimethyl sulfopropyl betaine, stearyidimethyl sulfopropyl betaine, lauryl dimethyl sulfoethyl betaine, lauryl bis-(2-hydroxyethyl)sulfopropyl betaine, and alkylamidopropylhydroxy sultaines.

The dispersing agent is intended to also include plasticizing agents. Examples of suitable dispersing agents includes glycidyl methacrylate (GMA), phthalates, phosphates, carboxylic acid esters, epoxidized fatty acid esters, polymeric polyesters, modified polymers, liquid rubbers, bisphenol A, alkylphenols, acrylates, anhydrides, amines, silanes, and the like.

According to some embodiments, the ratio between carbon nanotubes, nanoclay, and dispersing agents is about 20-50 parts carbon nanotubes by weight of total additive, to about 20-50 parts nanoclay by weight of total additive, to about 10-30 parts dispersing agents by weight of total additive. A preferred mixture employs about 40 parts carbon nanotubes by weight of total additive, to about 40 parts nanoclay by weight of total additive, to about 20 parts dispersing agents by weight of total additive. The combination of these ingredients forms a wet mixture that can then be incorporated proportionally (e.g., 1:1 ration) into polymeric plastics and resins utilizing selected incorporation methods. In some examples, the wet mixture can be incorporated in significantly less proportions into the polymeric plastics (e.g., less than 40 parts by weight of total material, less than 30 parts by weight of total material, less than 20 parts by weight of total material, less than 10 parts by weight of total material, less than 5 parts by weight of total material, or less than 2 parts by weight of total material). Importantly, resulting fire resistant materials incorporating the mixture maintain structural strength while also becoming self-extinguishing.

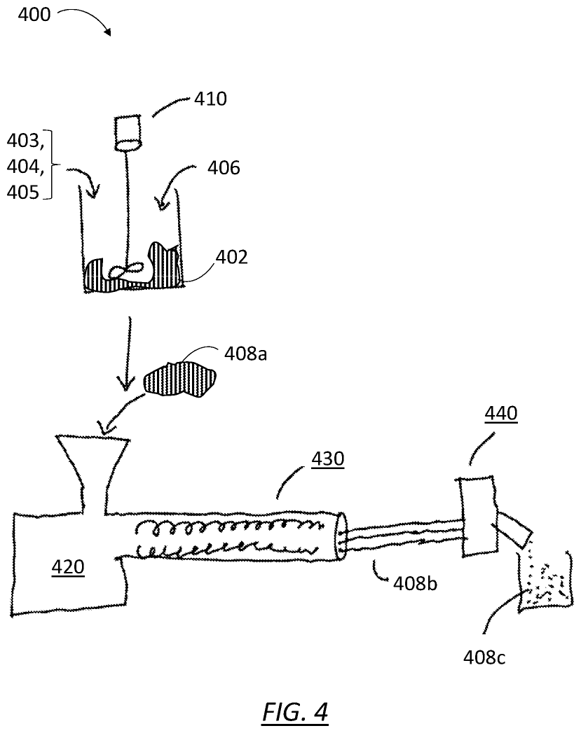

According to certain embodiments, a first incorporation method 400 for mixing or combining together the components of the fire resistant additive mixture 402 includes a melt mixing method, as shown in FIG. 4. The melt mixing method 400 utilizes a constant shear force from a mixing paddle 410, either manual or automatic (e.g., with a motor) for assist combining the carbon nanotubes 403, nanoclay 404, and dispersing agent 405 with polymeric plastic or resin 406. The resulting fire resistant material 408 can be formed into pellets 408c. This is achieved by placing the fire resistant material 408a inside an expander 420 with a mechanism to compound the fire resistant material 408 through a twin screw 430. The various zones of the extruder 420 can be heated to change the viscosity of the fire resistant material 408a, 408b. The various heat zones can be adjusted to achieve a suitable fire resistant material as a cured polymer and/or melt. As would be understood by one of skill in the art, the melt temperature range for certain polymeric resins can range between about 170° C. to about 350° C. In addition, or alternatively, the rotations per minute (RPMSs) of the screw machine 430 can be changed or varied to change the shear force rates applied to the fire resistant material 408a, 408b. The melted mixed plastic is then extruded and mechanically cut by a cutter 440 to form tiny beads or pellets 408c that can be easily molded and used later for incorporation into selected articles.

According to other embodiments, a second incorporation method 500 can be employed that involves incorporating the fire resistant additive mixture 502 including carbon nanotubes 503, nanoclay 504, and dispersing agent 505 combined with a monomer resin 506 that has not been polymerized and converted into plastic. Once emulsified and properly dispersed in the mixture 502 using shear force from mixing paddle 510, the monomer resin 506 is then polymerized adding an activation agent or a catalyst 509 to the mixture 502. The liquid resin forming the fire resistant material 508a can then start to cure and harden into a resultant fire resistant polymeric plastic 508b. The resultant fire-resistant polymeric plastic 508b or resin 508a includes therein a dispersed quantity of fire resistant mixture or additive 502. The resultant fire-resistant polymeric plastic is then extruded and mechanically cut by a cutter 540 to form tiny beads or pellets 508c that can be easily molded and used later for incorporation into selected articles.

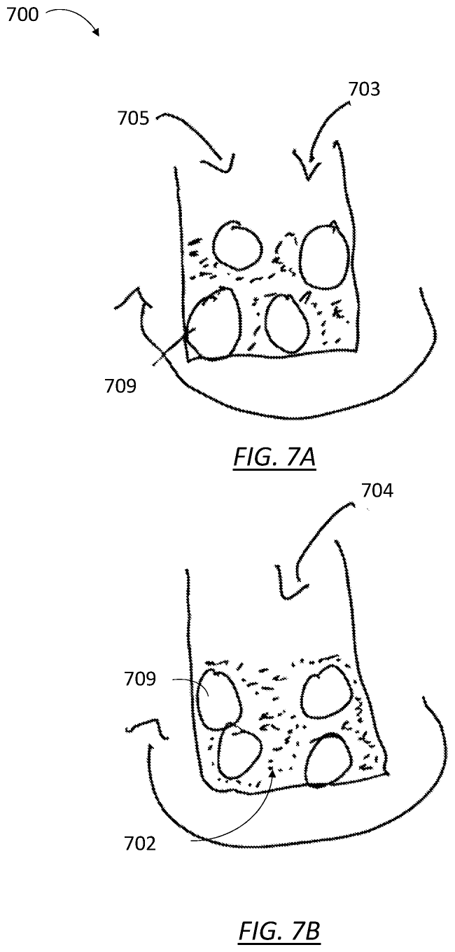

According to still another practice, a third incorporation method 600 can be employed that involves mixing the fire resistant additive mixture 602 including carbon nanotubes 603, nanoclay 604, and dispersing agent 605 including with a specific quantity with a polymeric powder 606. The two materials can be grafted together using pressure and shear force by methods described above (e.g., from mixing paddle 610 or extruder 620 with twin screw 630) or additional methods, such as for example, by ball milling for example with steel balls, shown more clearly in FIGS. 7A and 7B. The polymeric plastic 608a is then melted and heated by a temperature controller 615 to incorporate the fire resistant mixture/additive 602. The fused polymeric plastic 608b is then cut and shaped by a cutter 640 into beads or pellets.

In some embodiments, as shown in FIG. 7A, the fire resistant mixture 702 can be mixed together before being added to either the polymeric resin, the monomer resin, or the polymeric powder. As shown, method 700 can include mixing the carbon nanotubes 703 with the dispersing agent 705 and applying shear force by any suitable method described supra, such as ball milling with steel balls 709. The nanoclay 704 can be added to the mixture of FIG. 7A to form the fire-resistant mixture 702, as shown in FIG. 7B. The resulting mixture can be shaken horizontally, vertically, or rotated while steel balls 709 remain stationary. In addition, or alternatively thereto, the steel balls 709 can rotate while the containing holding mixture remains stationary. The resulting fire-resistant mixture 702 can be mixed for a time ranging from 10 minutes to 1 hour, or longer.

When the polymeric plastic or resin that includes a selected percentage of the fire resistant additive mixture is exposed to a flame, the plastic begins to heat up. As the plastic begins to combust, the plastic holds it shape and begins to convert itself into carbon ash. The carbon ash can absorb/conduct/reflect extreme heat preventing the further combustion of polymeric plastic or resin. If the mix is incorporated properly, when the plastic is next to extreme heat, the material can emit black body radiation.

As is understood, a selected amount of the fire retardant additive consisting of carbon nanotubes, nanoclay, and plasticizing agents can be loaded or incorporated into an article to exhibit the fire resistant properties. Further, depending on the loading by weight of polymeric plastic, the cured polymeric plastic and resin with the addition of fire retardant additive at a loading of 2% can increase the mechanical properties by 10% to 30% for each factor.

In addition, resulting fire resistant pellets or materials may be melted to be used as a paint or coating such that application of a layer of the fire resistant material may increase mechanical properties and fire resistance of a surface. Similarly, fire resistant pellets may be melted and molded into any article.

The following examples further illustrate aspects of the present disclosure. However, they are in no way a limitation of the teachings or disclosure of the present disclosure as set forth herein.

### EXAMPLES

### Example 1

The fire resistant additive mixture of the present invention can be made by utilizing carbon nanotubes (CNT), montmorillonite nanoclay, and glycidyl methacrylate (GMA) as a dispersing agent. The carbon nanotubes can have a purity of at least about 90% and a diameter in the range between about 15 nm and about 40 nm. The length of the carbon nanotubes can be any determined length. The nanoclay (e.g. montmorillonite clay) that has been modified with a surface modification that allows easier adherence to the plasticizing agent (e.g., tetra carbon chains attached to an ammonium group). The particle size of the nanoclay can be in the nanometer range, ideally under about 50 nm. The purity of the nanoclay can affect the final product, and preferably has a purity above about 90%. The purity of the plasticizing agent (e.g., glycidyl methacrylate (GMA)) can also affect the final product, and preferably has a purity above 90%.

The carbon nanotubes are placed in a steel ball mill alongside the plasticizing agent (e.g Glycidyl Methacrylate (GMA)). The present invention can be produced utilizing the following procedures and methods: two parts CNT to one part GMA can be grafted together. The two components are ball milled for about 15 to 20 minutes at relatively high rpms and high speeds. The CNT-GMA is then strained into a container. The strained CNT-GMA is then grafted with Montmorillonite Clay so that the final CNT-GMA-CLAY consists of 2 parts of CNT to 1 Part of GMA to 2 Parts of CLAY. The wet powder is then ball milled for about 30 to 40 minutes. The powder is then strained and stored in containers. To incorporate the powder into polymeric plastic or resin at scale, a portion of the plastic and a portion of the additive are milled together. The resulting coated polymeric pellets are then placed in a twin screw extruder with a specific temperature and specific rotational speeds. The machine can also have a specific L/D ratio. The final plastic can be extruded as a cylinder that can be precisely cut so that granules or pellets are produced. The resulting pellets or granules are mixed with a portion of polymeric plastic or resin so that the final desired loading percentage is achieved. The polymeric plastic and resin is then placed in a molding machine for shaping and fusing into a single crystal polymer.

The additive of the present invention produces polymeric plastics and resins that are mechanically stronger and more fire resistant relative to unmodified counterparts. This is done with low loading percentage by weight (1% to 7% by weight). The increase in tensile properties reduces how much plastic is needed for a product to keep the same strength.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A fire resistant material comprising:
a mixture comprising:
carbon nanotubes,
nanoclay, and
a dispersing agent; and
a material incorporating the mixture such that the material is self-extinguishing when exposed to a flame.

2. The fire resistant material of claim 1, the carbon nanotubes comprising approximately 25 percent by weight of the mixture.

3. The fire resistant material of claim 1, the nanoclay comprising approximately 50 percent by weight of the mixture.

4. The fire resistant material of claim 1, the dispersing agent comprising approximately 25 percent by weight of the mixture.

5. The fire resistant material of claim 1, the nanoclay comprising one or more silicates.

6. The fire resistant material of claim 1, the dispersing agent comprising a surfactant.

7. The fire resistant material of claim 1, the dispersing agent comprising a plasticizing agent.

8. The fire resistant material of claim 1, the material configured to be coated on a surface.

9. The fire resistant material of claim 1, the material configured to be molded.

10. A method comprising:
combining the mixture of claim 1 with a polymeric resin,
heating the mixture and the polymeric resin to form a fire resistant material, and
extruding the fire resistant material into pellets.

11. A method comprising:
combining the mixture of claim 1 with a monomer resin,
adding an activation agent,
heating the mixture and the monomer resin to form a fire resistant material, and
extruding the fire resistant material into pellets.

12. A method comprising:
combining the mixture of claim 1 with a polymeric powder under applied pressure,
heating the mixture and the polymeric powder to form a fire resistant material, and
extruding the fire resistant material into pellets.

13. A system as shown and described herein.

14. The system of claim 13, including each and every novel feature or combination of features shown and described herein.

15. A method as shown and described herein.

16. The method of claim 15, including each and every novel feature or combination of features shown and described herein.

17. A device as shown and described herein.

18. The device of claim 17, including each and every novel feature or combination of features shown and described herein.
